(19) United States
(12) Patent Application Publication
(10) Pub. No.: US 2007/0101316 A1
(43) Pub. Date: May 3, 2007

(54) Software Architecture and Program for the Concurrent Execution of Finite State Machine-Encoded Processes, on Single or Multiple-Processor-Based Embedded Systems

(75) Inventor: Don Carl Berndt, Maple Glen, PA (US)

Correspondence Address: Don Carl Berndt, 1560 Blair Lane, Maple Glen, PA, 19002-3016, US

(73) Assignee: Don Carl Berndt, Maple Glen, PA (US)

(21) Appl. No.: 11/531,266

(22) Filed: Sep. 12, 2006

Related U.S. Application Data
(60) Provisional application No. 60/716,327, filed on Sep. 12, 2005.

(51) Int. Cl. G06F 9/44

(52) U.S. Cl. 717/127

(57) ABSTRACT

A software architecture and design method for embedded computing system applications in which tasks consist of a common data structure (FIGS. 1, 2) and are encoded as a finite state machines (FIG. 5). An executive (FIGS. 3, 4) provides for the execution of each task's current state function, and a system timer (FIG. 6) provides timer services to selective tasks. The architecture supports inter-task communication capabilities with message pipes and flags (FIG. 7). System calls (FIG. 8) provide utility functions for high-level access to system constructs. This structured architecture and its components provide for real-time performance and deterministic behavior of an embedded application (FIG. 9).

### CROSS-REFERENCE TO RELATED APPLICATIONS

This application claims the benefit of provisional patent application Ser. No. 60/716,327, filed 2005 Sep. 12 by the present inventor.

### FEDERALLY SPONSERED RESEARCH

Not Applicable

### SEQUENCE LISTING OR PROGRAM

Not Applicable

### BACKGROUND OF THE INVENTION

1. Field of Invention

This invention discloses a new method of executing computer software processes, specifically to a method and architecture, appropriate for both single and multiple-processor computing systems, which improve upon system performance of embedded system applications, compared to prior art.

2. Prior Art

Embedded systems, such as medical, avionics, navigation and communication devices, differ from general-purpose (desktop) computer systems, primarily by their real-time performance requirements, as well as the critical nature of their application mission. However, much of the current art of embedded system software design is based on the architecture and design methods deployed in general-purpose computer operating systems. These operating systems were designed specifically to execute multiple, usually unrelated, applications concurrently, referred to as multi-tasking or multithreading. To address the performance requirements of embedded system applications, these basic operating system principles have been modified, allowing them to be considered ‘real-time’ operating systems, or RTOSes. However, these RTOS architectures still regard the embedded software processes as separate, unrelated applications. The criteria for partitioning an RTOS-based application into tasks is usually procedural-based, with each process typically implemented as a ‘while (TRUE)’ construct, its execution suspended at a fixed time interval via a context-switch to the next task. This results in inefficient use of the processor. Additionally, this method must allow for reentrant process functions and resource sharing across processes. Many RTOS architectures also provide for the dynamic prioritization of task execution by a scheduler, which complicates the deterministic behavior of the system. Regardless of the critical nature of the embedded application, current design standards recommend validation and verification of software designs, in attempt to ensure the safe and effective operation of the embedded application software. The basic architecture of an RTOS makes it more difficult to verify the embedded application's behavior in a dynamic, eventful environment.

A recent survey (as stated in Embedded Systems Design magazine, June 2006 issue) shows that 28.7% of current embedded projects do not use any form of an RTOS, with respondents citing reasons such as lack of need, inefficiency, cost and learning curve. The survey also reports that the remaining 71.3% who will use an RTOS cite that real-time performance is the most important issue in selecting a particular RTOS product. Overall, the results of the survey may suggest that a design method and architecture specifically for embedded system software design community is needed. Consequently, my invention is a solution to the performance issues stated within the survey, as well as providing a structured architecture and execution apparatus appropriate for all embedded system software applications.

This invention accomplishes the most efficient execution of concurrently running tasks, whereas each task is encoded as a Finite State Machine (Paul E. Black, ed., U.S. National Institute of Standards and Technology). Other inventions have claimed a unique use of state machines and their execution, but mostly within framework of an operating system.

For example, U.S. Pat. No. 7,007,004 (2006) specifically claims the use of operating system threadpools to generate instances of master/slave(hand) families of state machines. However, there is no stated special treatment of these state machines, in that they are executed as any other thread, state machine or otherwise. Additionally, the run-time allocation of state machine family threads, and context-switching thereof, does not suggest the utilization of usefulness of state machine process design, in that if an predefined event has not occurred for a given process that is in a defined state, then there is no reason for that process to utilize the processor, which is not addressed within the claims.

The Unified Modeling Language (UML) has recently accommodated the descriptive behavior of objects over time with its inclusion of statecharts. Based on the work of David Harel (“Statecharts: A Visual Formalism for Complex Systems from Science of Computer Programming, Vol 8, 1987), this enhancement to UML brings us closer to the benefits of thinking in terms of state machines, but possibly deviates from the more classical definitions provided by Mealy and Moore (as described in the NIST reference for Finite State Machines). Additionally, the use UML in high performance embedded systems has not yet been widely accepted (see Embedded.com—Jack Ganssle's Embedded Pulse 2006, August), and at this time, seems to be more popular for use within non-real-time applications.

Applying Finite State Machines to design principles for embedded systems has also been addressed in certain ‘visual design’ products, one of which is also based on UML state behavior description, the basis for which is addressed in U.S. Pat. No. 6,408,262—IAR Systems.

### OBJECTS AND ADVANTAGES

Accordingly, the objects and corresponding advantages of my invention include:
(a) a program that executes concurrent processes without the need for an RTOS or other operating system, which makes it ideally suited for a variety of embedded system hardware configurations (i.e. microcontroller(s), multiprocessors, limited memory resources, etc);
(b) a program and associated data structures together are architected for the sole purpose of executing (primary) state functions for each task, which results in superior performance and efficient use of the host processor;
(c) a program that executes each task's (primary) state function, allowing each state function to run to completion, thereby eliminating the need for inefficient context switching and code reentrancy concerns inherent in conventional RTOSes and operating systems;
(d) a set of utility functions, or system calls, that provide for the proper encoding of state machine states, which are based on the classical Mealy and Moore definitions cited in the NIST reference above;
(e) a program and architecture which will eliminate the issues related to resource sharing if the system is partitioned by resources, versus application processes, with each resource encoded as a state machine;
(f) a program whose execution of each task's current (primary) state function is performed within a loop construct, thereby eliminating the need for dynamic scheduling of processes, due to the inherent efficiencies of executing only a single state function for each task;

(g) a program and data structures whose overall structured architecture manifests purely deterministic behavior, which is easily verified by code inspection and analysis, and supports current design standards for safe and efficient embedded system software applications.

Additional objects and advantages of my invention include:
(a) a system timer program and associated utility functions, or system calls, which use a single hardware timer (interrupt) to provide timer services to any or all tasks;
(b) data structures and associated utility functions, or system calls, that provide for inter-task messaging;
(c) a customizable task data structure, which allows for the addition and settings of processor- and application-specific field elements and size;
(d) an overall architecture that is ideally suited for the distribution of application tasks among multiprocessors or multi-core elements of a computing system.

### SUMMARY

In accordance with the present invention, a software architecture and design method for embedded system applications, which consists of the following components: tasks encoded as finite state machines and sharing a common data structure, an executive that executes the current state function for each task, a system timer to provide timing services to selective tasks, inter-task communication capabilities, and a set of system calls to provide access to system constructs.

### DRAWINGS-FIGURES

The operation and interaction of the objects of the software program and architecture disclosed in my invention can be more clearly understood in the ensuing descriptions, in conjunction with the following figures:

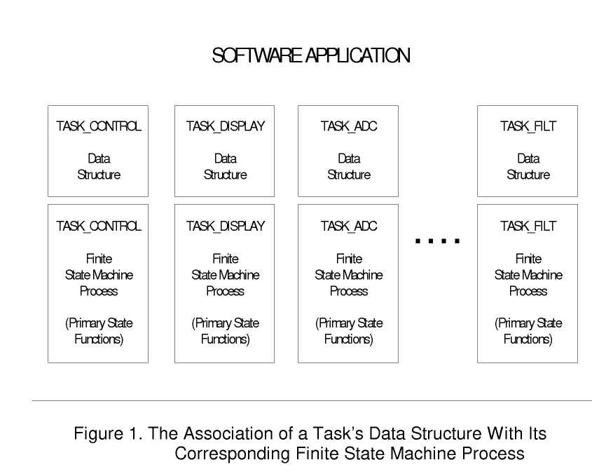

a) FIG. 1 provides a visual representation of the association of the Task Data Structure with its state machine-encoded process in an example software application that is partitioned by resources.

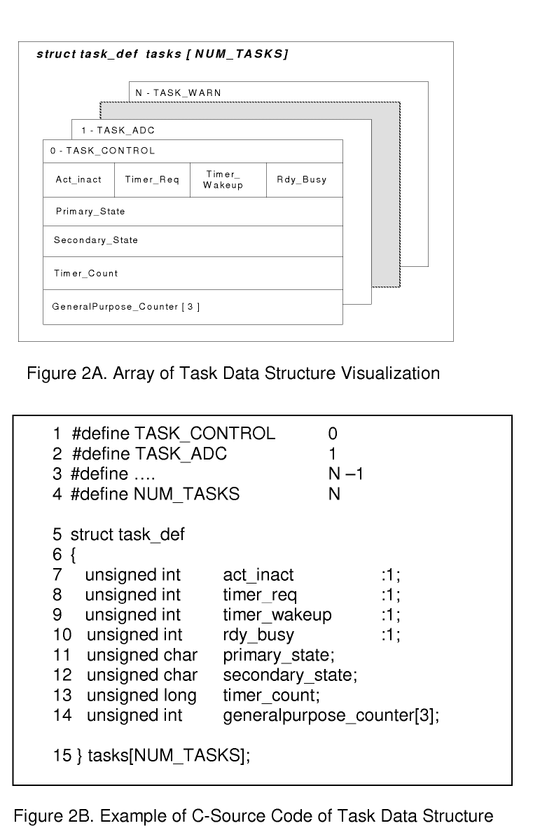

b) FIGS. 2A and 2B provide a visualization of a typical Task Data Structure Array and its C-source code respectively. The Task Data Structure definition is analogous to, in form and function, the internal registers of a general-purpose microprocessor.

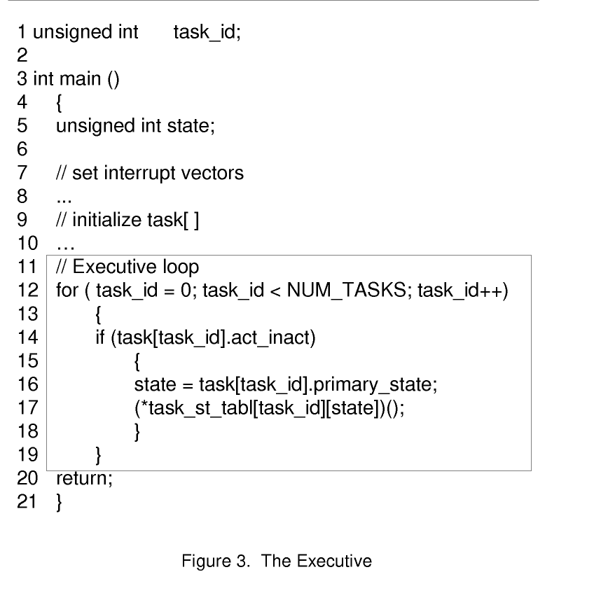

c) FIG. 3 provides a C-source code example of a basic executive.

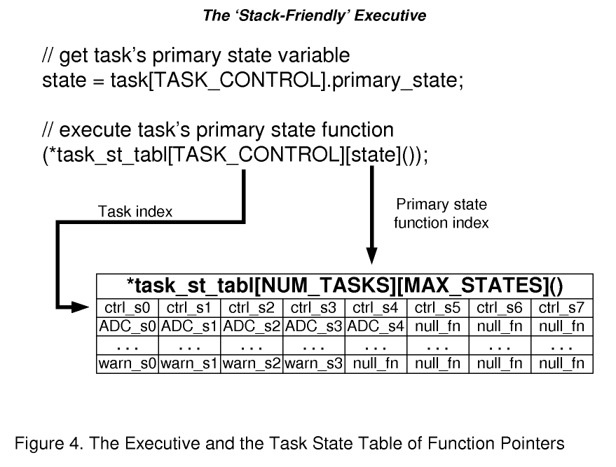

d) FIG. 4 shows the Executive and the Task State Table of Function Pointers. This figure provides the precise details of how the Executive indexes to, and executes, the current task's current primary state function.

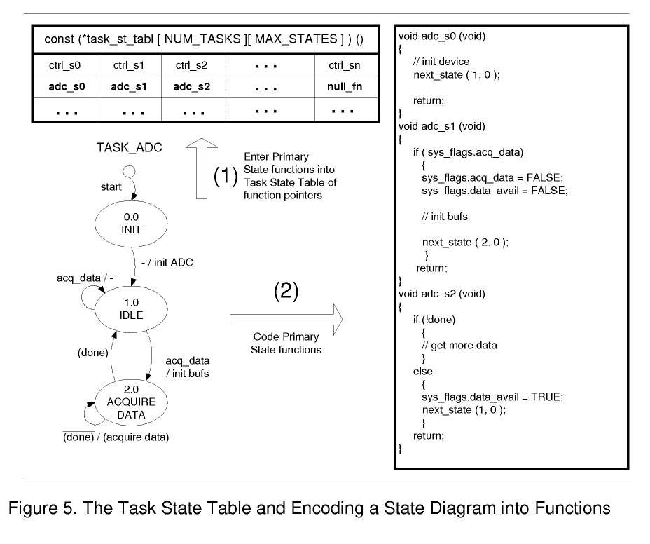

e) FIG. 5 shows the steps involved in encoding a task's state diagram into primary state functions, which are then entered into the Task State Table to be accessed by the Executive. An Analog-to-Digital Converter task is shown as an example.

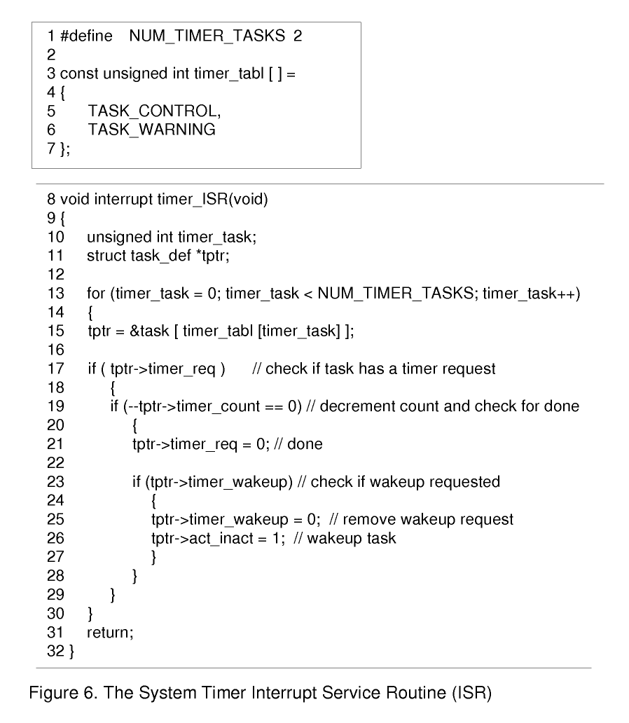

f) FIG. 6 provides a C-source code example of the System Timer Task Look-Up-Table and the System Timer Interrupt Service Routine (ISR).

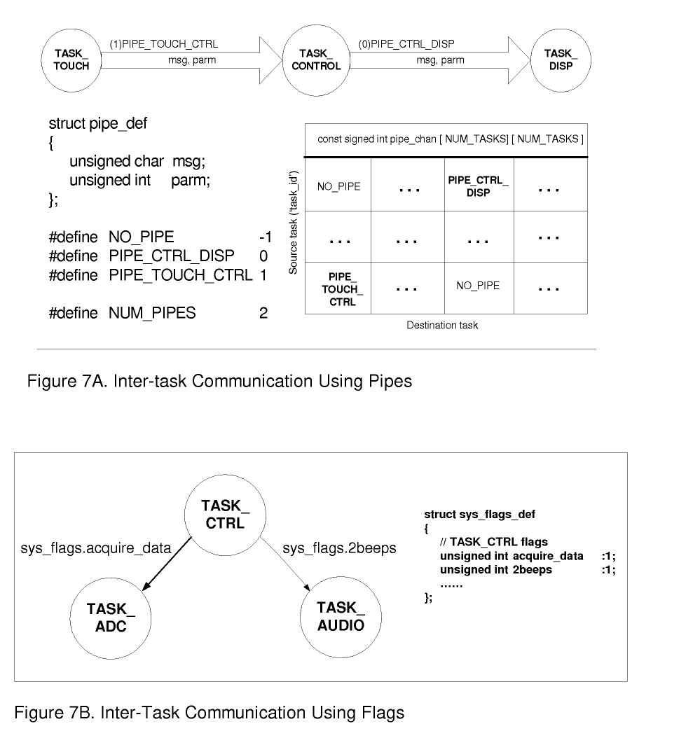

g) FIGS. 7A and 7B show how Inter-Task Communication can be achieved using pipes and flags. Pipes are used within the architecture to allow messages, and optional parameters, to be sent from one task to another. Bit flags may be used to signal an event among tasks.

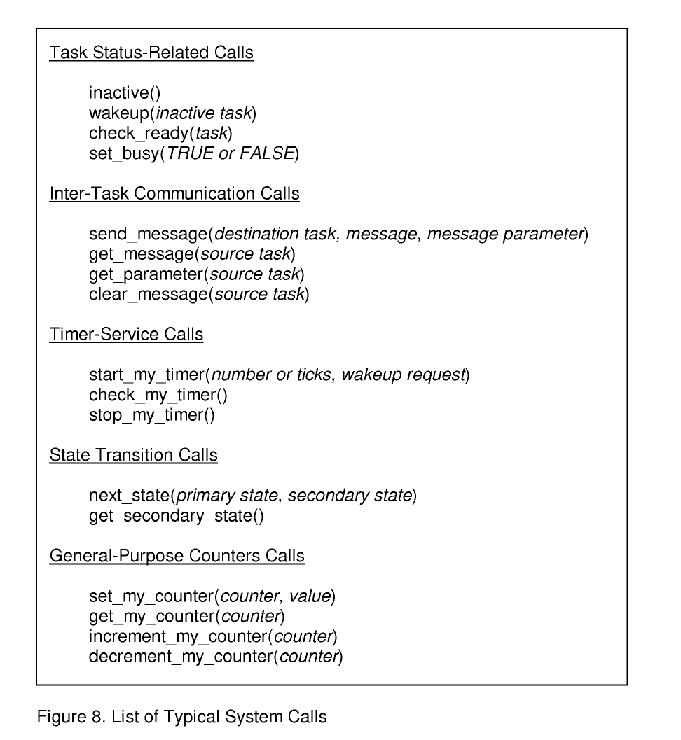

h) FIG. 8 is a list of typical System Calls grouped by usage types.

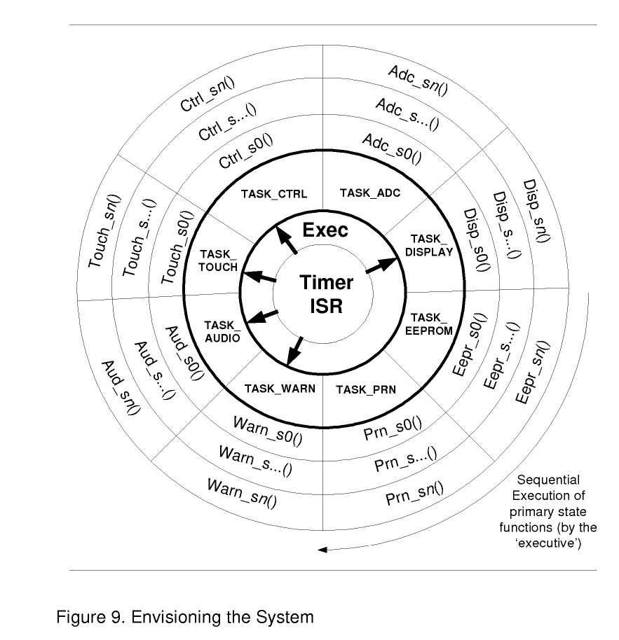

i) FIG. 9 provides a way to envision a sample application. It shows the Executive, tasks and their respective state functions, with timer services provided to selective tasks.

### DETAILED DESCRIPTION—PREFERRED EMBODIMENT—FIGS. 1-9

The preferred embodiment of this invention contains the program and data structures comprising the overall architecture and consists of the Executive, the Task Data Structure, the System Timer services and the System Calls. Each of these objects is described in conjunction with the cited figures.

FIG. 1 shows the preferred way of partitioning an embedded software application using this architecture. The partitioning criterion shown in this example considers each of the hardware resources a task. The figure shows a display and an Analog-to-Digital Converter (ADC) as resources typically found in embedded systems. The figure also shows a Control Task and a Filter Task, which, although not hardware resources, are processes that qualify, using this partitioning criterion, as tasks whose behavior can be described as a Finite state Machines. This figure therefore attempts to convey the partitioning criterion that any required operation related to the monitor or control of internal or external devices, algorithmic processing of data, or communication protocol should be assigned as a task. The Control Task is considered to perform supervisory control over all other tasks, as well as to manifest the state of the entire application. In this role, the Control Task will translate user input and other events into actions to be performed by other tasks.

FIG. 1 also depicts the two parts of each task: the Task Data Structure and the Finite State Machine-encoded process, which consists of primary state functions to be executed by the Executive.

FIG. 2A is a visualization of the array of the Task Data Structure. It should be observed that the structure's fields are intended to be analogous to the internal registers of a general-purpose microprocessor, so that along with a process state machine program code, the pair could be regarded as a standalone computing subsystem. This unique concept and resulting embodiment is the basis for further embodiments, in which tasks can be easily distributed across multiple processors or multi-core processing elements.

FIG. 2B is an example of how the Task Data Structure is defined and declared as an array. In lines 1-3 tasks are defined sequentially as constants, with the total number of tasks being defined on line 4. Lines 5-14 show the actual definition of the Task Data Structure and line 15 declares the array to be of size NUM_TASKS. It should be noted that Task Data Structure Array is declared at design time and will reside in RAM memory, as the field variables will be changing constantly during runtime. This method of declaring tasks at design time obviates the need to dynamically allocate memory resources to task threads during runtime, as is typical in prior art operating systems.

FIG. 3 is the C-source code for a basic Executive, which is responsible for the execution of tasks' process state machine functions. Its functionality will be discussed in detail as part of the Operation of this invention.

FIG. 4 shows how the Executive indexes into the Task State Table of state function pointers based on the ‘task_id’ variable and the current task's primary state variable as part of the Task Data Structure. The functional details this aspect will also be described in the Operation of this invention.

FIG. 5 depicts the design time process of encoding a task's state machine process into individual functions to be executed by the Executive. Each state in the state diagram is embodied as a single Primary State Function. Its function name is first entered into the appropriate location within the Task State Table (1), as it will be accordingly indexed by the Task's Primary State variable via the Executive. The Primary State Functions are then encoded into a code module (2), using the System Calls to obtain System Timer services, perform Inter-task communication, manipulate task counters and to effect state transitions. The figure depicts this design time process using an Analog-to-Digital Converter Task as an example. However, this design time process must be performed for all tasks within the application.

FIG. 6 is the C-source code for the System Timer. The details of its operation and usage by tasks are provided within the Operation section of this Specification.

FIG. 7A shows the data structure and constants used in the Inter-task Communication using Pipes capability of this architecture. It is used by tasks to both send and receive a message between two tasks. This aspect of the communication capabilities of this architecture will be discussed further within the Operation section of the Specification.

FIG. 7B shows how bit flags are used as part of the Inter-task Communication capabilities of this embodiment of the architecture. Its detailed operation and usage by tasks will be discussed further within the Operation section of this Specification.

FIG. 8 is a list of the System Calls that are part of the current embodiment of this architecture. The functions are representative of utility functions that are available to the software designer when encoding each task's state machine process module. The System Call functions shown are grouped according to the type of service provided by the functions. Most of these functions use the global variable ‘task_id’ set by the Executive (see FIG. 3), which identifies the task calling the function. Additionally, most of these System Calls access the field variables of the Task Data Structure.

FIG. 9 provides an abstract visualization of a representative application using the architectural components of this invention. Shown within the center of the figure are the Executive and the System Timer ISR, which illustrates the central functionality of these components to the entire system. Moving outward, the Executive interfaces to the tasks via their respective Task Data Structure. Each task is then associated with its respective Finite State Machine process, shown as the individual Primary State Functions along the outer rings of the figure. This representation attempts to convey how the Executive will execute each task's current Primary State Function as it cycles counterclockwise through the list of tasks.

### OPERATION OF THE INVENTION—FIGS. 1-9

One of the preliminary steps required to implement the architecture of this invention is to partition the embedded software application as shown in FIG. 1. The recommended criterion for such partitioning is to assign a task to processes responsible for: a) driving internal or external resources, such as keypads, analog-to-digital converters, audio devices, displays, etc., b) algorithmic processing of data, such as filters, display and file formatting, and c) the various layers of communication protocols.

The resulting lists of tasks are defined as shown in the C-source code FIG. 2B, along with an appropriate Task Data Structure definition, as illustrated in FIGS. 2A and 2B. The Task Data Structure must contain the ‘primary state’ and ‘active-inact’ field variables, as they are required by the Executive to execute each task's Primary State Function. The remaining fields of the Task Data Structure are also required, due to their use by the System Calls and the System Timer, as part of this embodiment of the architecture.

In addition to having the Task Data Structure, each task also consists of a Finite State Machine encoded in its process module, as shown in FIG. 5. In the example, an ADC Task state diagram is shown. Each of these states is encoded as a single Primary State Function, and its function name is entered into the Task State Table according to an arbitrary number sequence. The location of the Primary State Function within this table is significant to the extent that it will be indexed by the Executive based on the current value of the Primary State variable within the task's Task Data Structure. The task itself will use the ‘next_state(primary state, secondary state)’ System Call to set these state variables within its Task Data Structure. The Executive will execute only the task's Primary State Function, and within that function, the ‘secondary_state’ variable may be used to provide further granularity of sub-states within that Primary State Function.

The System Calls component of this embodiment of this architecture provides a set of utility functions that may be used within each task's Finite State Machine process code. FIG. 8 contains the list of these functions grouped appropriately. Most of these functions rely on the ‘task_id’ global variable to identify the calling task. All of these System Calls access or manipulate the field variables of the calling task's Task Data Structure.

The actual execution of an embedded system application is performed by the Executive program; a basic embodiment of such is conveyed in the C-source code in FIGS. 3 and 4. The Executive interfaces directly with each task through ‘active_inact’ and ‘primary_state’ fields of the Task's Data Structure, and indirectly with each task via the Task State Table of Primary State Function pointers. The Executive will use the loop variable ‘task_id’, declared globally on line 1 in FIG. 4 to access each task's Task Data Structure. If the task is active, as shown on line 14, the task's ‘primary_state’ variable is acquired, and along with the ‘task_id’ variable, is used to execute that task's Primary State Function, as shown on line 17. The details of how this is accomplished are shown in the example of FIG. 4. To simplify the explanation, the ‘task_id’ loop variable is replaced with TASK_CONTROL, having a value of zero, and its current ‘primary_state’ value is (4). In the figure, TASK_CONTROL is used as the row index into the Task State Table, which contains all of the defined Primary State Functions for TASK_CONTROL. The current state value is used to index the proper column, which, in this example, contains the function pointer to ‘ctrl_s4’. Other Primary State Functions of TASK_CONTROL will be executed as the task uses the ‘next_state( )’ System Call within its process state machine. The identical process is used to execute the Primary State Functions for all other tasks within the Executive loop.

FIG. 6 is the C-source code for the System Timer component of this architecture. Depending on the application requirements, not all tasks may require timer services. Therefore, a constant Look-Up-Table must be generated at design time, which lists those tasks that will be serviced by the System Timer. In this example, line 1 defines the constant number of tasks that will be serviced, and lines 3-7 provide the list of those tasks. The System Timer Interrupt Service Routine (ISR) is shown on lines 8-21. The Timer ISR will loop through the list of tasks (lines 13-30) setting a pointer to the selected task (lines 10,11 and 15) to allow efficient access to the task's timer flags and value. Note that the listed timer tasks will use System Calls to request and obtain timer services. The ISR will check if the selected task has an outstanding request (line 17), and if so, will decrement the task's timer value on line 19. If the decremented value is zero, the request is cleared (line 19) and the task is set active if required on lines 23-27.

FIG. 7A shows the data structure and constants for an example of Inter-task communication using one-way pipes. The example in the figure shows a communication pipe between the Touch-Screen Task and the Control Task. Likewise, a pipe connects the Control Task with the Display Task. This scenario could represent a user input event, resulting in a change in the display. The structure definition allows for a message and message parameter, as shown, and individual pipes between tasks are defined as constants. As these communication pipes are installed at design time, a constant, two-dimensional Look-Up-Table is constructed to contain the defined pipes between the source and destination tasks. As shown, the message source ‘task_id’ indexes the row, and the destination ‘task_id’ indexes the column. Tasks will use the System Calls ‘send_msg( )’ to send a message to another task, and ‘get_msg( )’ and ‘clr_msg( )’ to obtain and clear a received message.

FIG. 7B shows how bit flags may also be used reliably to signal events to other tasks. In this architecture, a single task can assert a specific flag, while other tasks' state machine process would react to its assertion as a defined event. In this figure, the usage example shows the Control Task sourcing two specific request events: one to signal the ADC Task to begin acquiring data, and the other to signal the Audio Task to sound a tone. In both cases, the receiving tasks' current states will regard these signals as events, and would perform some action and transit to another state, as designed. This method illustrates the tight coupling of task state machine designs, and particularly, well-defined interactions among the tasks.

The architecture and components of this invention provide a unique and useful method for the design, development and verification of embedded system software. It's structured architecture and modularization of tasks is well-suited for applications to be deployed on both single and multiple processor/multi-core computer system configurations. The Executive, Task Data Structure and Task State Table components allow for a most efficient way to execute multiple tasks encoded as Finite State Machines, resulting in superior real-time performance relative to prior art. The System Timer component provides timer services efficiently to the system tasks, and the System Calls and Inter-task Communication components reduce the effort in programming tasks' state machine processes. This architecture also allows for a reasonable amount of customization to enhance its operation for specific needs of any application.

### ALTERNATIVE EMBODIMENTS

The present embodiment of this architecture and its components represents the core concepts of this invention, and provides the framework in which enhancements will naturally evolve through usage within the embedded software development market. Examples of such enhancements might include, but are not limited to, the following:
a) Allowing more than one list of tasks to be executed could enhance the Executive component. Specifically, either at design time or dynamically during runtime, lists of subsets of system tasks could be generated, allowing the Executive to focus on specific tasks in response to system load or specific events. This would be analogous to scheduling and task prioritization present in prior art.
b) The selective mapping of multiple related tasks to a single process state machine would improve the efficiency of design.
c) The inclusion of elapsed time services provided to tasks by the System Ti mer.

### CONCLUSION AND RAMIFICATION

These example embodiments represent a next step forward in software development by providing an architecture that is based on sound engineering principles: specifically Finite State Machines. This architecture manifests a multiple processor model, each processor being responsible for managing a device, interface, communication protocol, or algorithmic processing of data. The ‘programs’ associated with these processors are designed as finite state machines and are coded directly as ‘state functions’ to be executed by the Executive. The architecture's components include the Executive and System Timer, along with Inter-task Communication capabilities and very useful System Calls.

This architecture, as presented here, reveals design concepts that can greatly benefit the entire product/software development cycle in many industries. This embodiment in the C-Programming Language is presented to convey these concepts. The constructs work perfectly in this form, however, it is important to understand that these ‘core’ concepts may be customized/modified to accommodate various software development tools or the application itself.

This innovative method provides an alternative solution for designing software applications that have real-time performance requirements beyond those found in typical desktop applications. This method and its architecture also support the strict quality control standards found in the medical device and military/avionics industries. It is therefore likely, that the architecture and method presented here, will possibly become an industry standard, as its many benefits are realized over time. It is likely that existing providers of RTOSes will be interested in incorporating these concepts (through licensing) into existing or new products. Current providers of software development tools will benefit (again, through licensing) by incorporating this architecture into their suite of products in support of existing and new microprocessors/microcontrollers. Because of the sound engineering principles underlying this architecture, it is also possible that this architecture, in its entirety, or in part, may be realized in silicon, as these concepts evolve and are refined for specific industry segments.

Given the variety of example embodiments of the present invention just described, the above description and illustrations should not be taken as limiting the scope of the present invention.

While the invention has been particularly shown and described with reference to the preferred embodiments thereof, it will be understood by those skilled in the art that various changes in form and details may be made without departing from the spirit and scope of the invention. It is intended to cover various modifications and similar arrangements and procedures, and the scope of the appended claims and subsequently added claims therefore should be accorded the broadest interpretation so as to encompass all such modifications and similar arrangements and procedures.

1. A software architecture and design method for embedded system applications, comprising:
(a) a means of encoding application tasks that consist of a common data structure and individual processes structured as finite state machine state functions,
(b) an executive function that executes each task's current state function using a lookup table of function pointers,
(c) a system timer interrupt-service-routine (ISR) that provides timer services to selected tasks,
(d) a means for providing inter-task communications using message pipes and flags,
(e) a set of system call utility functions to provide high-level programming access to system constructs,
whereby this architecture and design method results in improved performance and deterministic behavior of an application.

2. A method of using the software architecture of claim 1.
